(19) United States
(12) Patent Application Publication
(10) Pub. No.: US 2026/0368889 A1
(43) Pub. Date: Nov. 19, 2026

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: NAOKI MATSUKI, Tokyo (JP); SHUNYA UENO, Tokyo (JP)

(21) Appl. No.: 19/674,315

(22) Filed: May 12, 2026

(30) Foreign Application Priority Data
May 19, 2025 (JP) 2025-083496

(51) Int. Cl. G06T 7/00; G06T 7/11; G06T 7/13; G06V 10/25; G06V 10/774

(52) U.S. Cl. CPC G06T 7/0012; G06T 7/11; G06T 7/13; G06V 10/25; G06V 10/774; G06T 2207/10132; G06T 2207/20081; G06T 2207/30068; G06T 2207/30096; G06T 2207/30168; G06V 2201/03

(57) ABSTRACT

An image processing apparatus comprising: a memory storing instructions, and at least one processor configured to execute the instructions to obtain an ultrasound image by capturing at least a portion of a breast; obtain first region information and second region information as region information of a lesion candidate region and region information of a mammary gland candidate region included in the ultrasound image; set a target area for inferring characteristic information concerning a characteristic of the lesion candidate region based on the first region information and the second region information; obtain an inference model that infers the characteristic information; and obtain the characteristic information by inference using the inference model based on the ultrasound image and the target area.

### BACKGROUND

### Field of the Technology

The present disclosure relates to an image processing apparatus, an image processing method, and a non-transitory computer-readable storage medium.

### Description of the Related Art

In recent years, various kinds of medical information have been used for diagnosis, and expectations for a system in which a user such as a doctor uses, as an aid for diagnosis, a result obtained by analyzing medical information including medical images by a computer have been increasing.

Non-patent literature 1 discloses a method of using an image obtained by cutting out a region of a mass when analyzing an ultrasound image of a breast by a computer. Patent literature 1 discloses a method of adjusting a region used for inference in accordance with the type of a finding to be obtained when obtaining an imaging finding of a nodule in a Computer Tomography (CT) image of a lung.

### CITATION LIST

Patent literature 1: Japanese Patent Laid-Open No. 2019-191772
Non-patent literature 1: The uncertainty of boundary can improve the classification accuracy of BI-RADS 4A ultrasound image (Huayu Wang et al., 2022) (PubMed)
Non-patent literature 2: ACR BI-RADS ATLAS 5th Edition (American College of Radiology)
Non-patent literature 3: The guidelines for breast ultrasound diagnosis 4th Edition (The Japan Association of Breast and Thyroid Sonology)
Non-patent literature 4: Grad-CAM: Visual Explanations from Deep Networks via Gradient-based Localization (arXiv)

If, in an ultrasound image including a breast within an imaging range, a mammary gland follows a course that avoids an abnormal shadow, this indicates that a characteristic of the abnormal shadow is benign. Therefore, when a model for inferring the characteristic information of a region (to be referred to as a lesion candidate region hereinafter) including an abnormal shadow, such as the degree of benignity or malignancy, is used, it is expected to improve the inference performance of the benignity by inputting, to the model, a wide region including a mammary gland candidate region around the lesion candidate region.

However, the state of an ultrasound image changes depending on imaging parameters, the presence/absence of artifacts, and the like, and the course of the mammary gland does not always clearly appear on the image. In this case, an input image includes information unnecessary for inference of the characteristic information, and inference is performed from the unnecessary portion in the image, thereby lowering the inference performance.

In the method described in each of patent literature 1 and non-patent literature 1, a region is decided regardless of the state of the mammary gland in the image, and it is thus impossible to prevent unnecessary information from being input to an inference model.

### SUMMARY

The present disclosure provides an image processing technique with high inference performance for inferring information concerning characteristics of a breast from an ultrasound image.

According to one aspect of the present disclosure, there is provided an image processing apparatus comprising: a memory storing instructions, and at least one processor configured to execute the instructions to obtain an ultrasound image by capturing at least a portion of a breast; obtain first region information and second region information as region information of a lesion candidate region and region information of a mammary gland candidate region included in the ultrasound image; set a target area for inferring characteristic information concerning a characteristic of the lesion candidate region based on the first region information and the second region information; obtain an inference model that infers the characteristic information; and obtain the characteristic information by inference using the inference model based on the ultrasound image and the target area.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an example of the hardware configuration of an image processing apparatus according to the first embodiment;

FIG. 2 is a block diagram showing an example of the functional configuration of the image processing apparatus according to the first embodiment;

FIG. 3A is a flowchart exemplifying an overview of the processing of the image processing apparatus according to the first embodiment;

FIG. 3B is a flowchart illustrating an example of the processing of the image processing apparatus according to the first embodiment;

FIG. 4 is a view showing examples of a lesion candidate region and a mammary gland candidate region according to the first embodiment;

FIG. 5 is a view showing an example of a method of dividing a mammary gland candidate region into patch images according to the first embodiment;

FIG. 6 is a view showing examples of a target area according to the first embodiment;

FIG. 7 is a view showing examples of a target area according to the first embodiment;

FIG. 8 is a table showing an example of a correspondence table between an aspect ratio and an inference model according to the first embodiment;

FIG. 9 is a view showing an example of the configuration of an inference model according to the first embodiment;

FIG. 10 is a view showing an example of a method of displaying characteristic information according to the first embodiment;

FIG. 11 is a view showing an example of an edge extraction filter according to the first embodiment;

FIG. 12 is a view showing an example of a method of using a patch image according to the first embodiment;

FIG. 13 is a view showing an example of a method of using a patch image according to the first embodiment;

FIG. 14 is a view showing an example of segmentation of a mammary gland candidate region according to the first embodiment;

FIG. 15 is a view showing an example of a linear structure in a mammary gland candidate region according to the first embodiment;

FIG. 16 is a view showing examples of a training image of an inference model according to the first embodiment;

FIG. 17 is a view showing an example of extension of a target area according to the first embodiment;

FIG. 18 is a view showing an example of a method of deciding a target area regardless of an aspect ratio according to the first embodiment;

FIG. 19 is a flowchart illustrating an example of the processing of an image processing apparatus according to the second embodiment; and

FIG. 20 is a table showing an example of a correspondence table between the visibility of a mammary gland and an aspect ratio according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

An image processing apparatus according to the first embodiment automatically infers, from an ultrasound image obtained by capturing a breast, information (to be referred to as characteristic information hereinafter) concerning characteristics of a lesion candidate region in the image, and displays the result. The image processing apparatus according to the first embodiment changes, in accordance with the visibility of a mammary gland in the ultrasound image, the aspect ratio of an area (target area) to be referred to when inferring characteristic information.

### (Hardware Configuration)

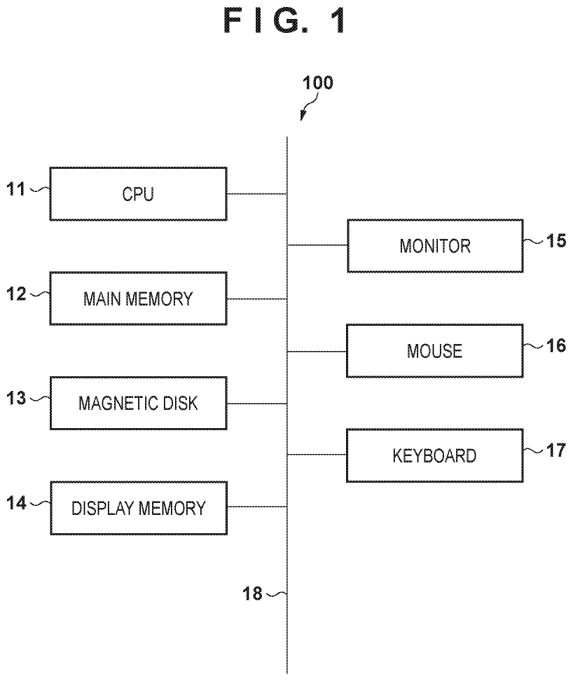

FIG. 1 is a block diagram showing an example of the hardware configuration of an image processing apparatus according to this embodiment. A CPU 11 mainly controls the operation of each component. A main memory 12 stores a control program to be executed by the CPU 11 and provides a work area at the time of executing a program by the CPU 11. A magnetic disk 13 stores an operating system (OS), the device drivers of peripheral devices, and programs for implementing various kinds of application software programs including programs for performing processing to be described later and the like. When the CPU 11 executes the program stores in the main memory 12 or the magnetic disk 13, the function (software) of the image processing apparatus according to this embodiment is implemented.

A display memory 14 temporarily stores, for example, display data for performing display on a monitor 15. The monitor 15 is, for example, a CRT monitor, a liquid crystal monitor, or the like, and displays an image, text, and the like based on the data from the display memory 14. A mouse 16 and a keyboard 17 are used by the user to perform pointing input and input of a character and the like, respectively. The above-described components are communicably connected by a common bus 18.

Note that the configuration of an image processing apparatus 100 is not limited to the above one. For example, the image processing apparatus 100 may include a plurality of processors. Furthermore, the image processing apparatus 100 may include a GPU and a Field-Programmable Gate Array (FPGA) programmed to perform some processes.

### (Functional Configuration)

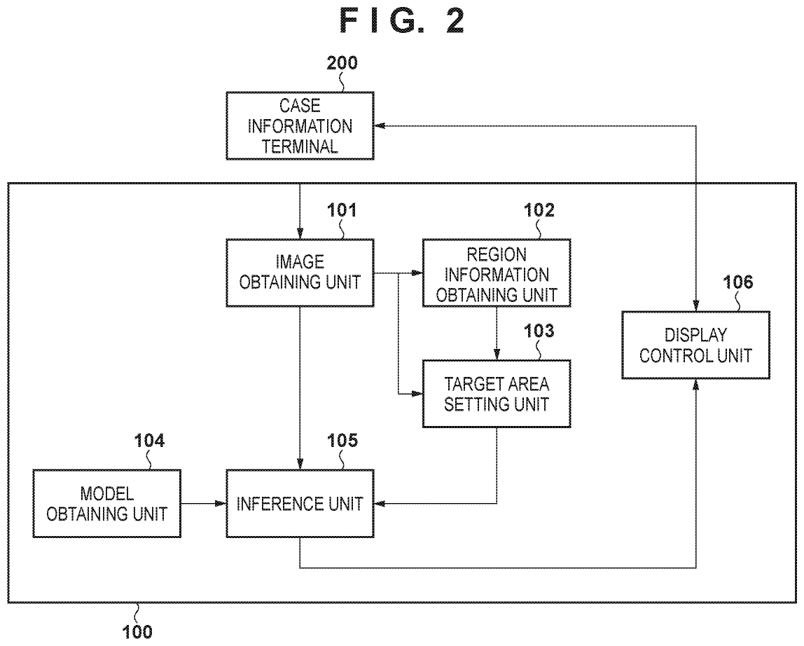

FIG. 2 is a block diagram showing an example of the functional configuration of the image processing apparatus according to this embodiment. The image processing apparatus 100 is communicably connected to a case information terminal 200. The image processing apparatus 100 includes an image obtaining unit 101, a region information obtaining unit 102, a target area setting unit 103, a model obtaining unit 104, an inference unit 105, and a display control unit 106. The functional components of the image processing apparatus 100 are connected by an internal bus or the like.

The case information terminal 200 obtains information concerning a case as a diagnosis target from a server (not shown). The information concerning a case is, for example, medical information such as a medical image and clinical information described in an electronic medical record. The case information terminal 200 may be connected to, for example, an ultrasound image diagnosis apparatus, and obtain an ultrasound image based on the operation of an ultrasound probe by a doctor. The case information terminal 200 may be connected to, for example, an external storage device (not shown) such as an HDD, Solid State Drive (SSD), CD drive, or DVD drive, and obtain a medical image from the external storage device.

The case information terminal 200 provides, via the display control unit 106, a GUI for prompting the user to select one of obtained ultrasound images. The selected ultrasound image is displayed on the monitor 15. The case information terminal 200 transmits, to the image processing apparatus 100 via a network or the like, the ultrasound image selected by the user via the GUI. Note that the ultrasound image transmitted to the image processing apparatus 100 is not limited to selection by the user, and ultrasound images obtained in real time based on the operation of the ultrasound probe by the doctor may be successively transmitted to the image processing apparatus 100.

The image obtaining unit 101 obtains the ultrasound image transmitted from the case information terminal 200 to the image processing apparatus 100.

The region information obtaining unit 102 obtains region information of a lesion candidate region and region information of a mammary gland candidate region included in the ultrasound image obtained by the image obtaining unit 101.

Based on the ultrasound image obtained by the image obtaining unit 101 and the region information of the lesion candidate region and the region information of the mammary gland candidate region obtained by the region information obtaining unit 102, the target area setting unit 103 sets an area (to be referred to as a target area hereinafter) in the ultrasound image to preferentially undergo inference processing of the succeeding stage.

The model obtaining unit 104 obtains a model (inference model) for inferring the characteristic information of the lesion candidate region based on the ultrasound image. Assume that this model is constructed in advance by deep learning or the like, and stored in the magnetic disk 13, an external server (not shown), or the like.

The inference unit 105 infers the characteristic information of the lesion candidate region included in the ultrasound image based on the ultrasound image obtained by the image obtaining unit 101 and the target area obtained by the target area setting unit 103.

The display control unit 106 displays the characteristic information obtained by the inference unit 105 on the monitor 15 together with the ultrasound image and the GUI.

### (Processing Procedure)

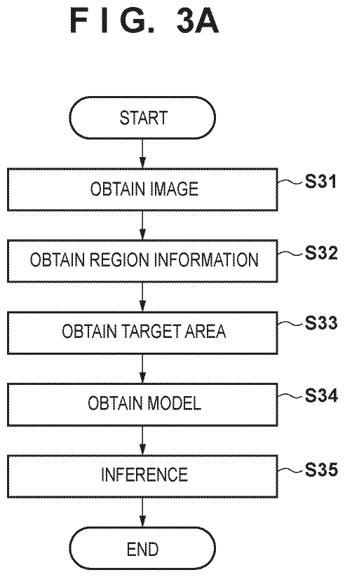

FIG. 3A is a flowchart exemplifying an overview of the processing of the image processing apparatus according to the first embodiment. In step S31, the image obtaining unit 101 obtains an ultrasound image by capturing at least a portion of a breast.

In step S32, the region information obtaining unit 102 obtains first region information and second region information as the region information of the lesion candidate region and the region information of the mammary gland candidate region included in the ultrasound image.

In step S33, based on the first region information and the second region information, the target area setting unit 103 sets a target area for inferring characteristic information concerning characteristics of the lesion candidate region.

The target area setting unit 103 sets the target area so as to include the mammary gland candidate region and the lesion candidate region and to obtain high occupancy of the mammary gland candidate region and the lesion candidate region in the target area.

When a depth direction is set as a vertical direction and a direction intersecting the depth direction is set as a horizontal direction, the target area setting unit 103 sets the target area based on information concerning the visibility of the mammary gland candidate region so as to have a representative vertical length in the vertical direction, a representative horizontal length in the horizontal direction, and an aspect ratio as a ratio obtained by dividing the representative vertical length by the representative horizontal length based on the second region information.

The target area setting unit 103 sets the target area based on the aspect ratio having positive correlation in accordance with the visibility of the mammary gland candidate region.

In a case where the target area is partially included in the ultrasound image, the target area setting unit 103 sets the target area by at least one of a method of assigning a random noise value as a pixel value with respect to a target area located outside the ultrasound image and a method of extending a target area located outside the ultrasound image by a generation target area image generated based on a target area partially included in the ultrasound image.

The target area setting unit 103 divides the mammary gland candidate region into a plurality of regions along the representative horizontal length of the lesion candidate region, obtains information concerning visibility for each divided region, and then obtains information concerning the visibility of the mammary gland candidate region by integrating the pieces of information concerning the visibility of the divided regions. The target area setting unit 103 performs processing of extracting an edge from the ultrasound image, obtains, as a linear structure included in the ultrasound image, the edge extracted by the processing, and evaluates the information concerning the visibility of the mammary gland candidate region in accordance with whether the linear structure continues by exceeding the representative horizontal length of the lesion candidate region. The target area setting unit 103 sets the target area so as to include the lesion candidate region based on the first region information.

In step S34, the model obtaining unit 104 obtains an inference model for inferring characteristic information. The model obtaining unit 104 obtains an inference model from a plurality of inference models. The plurality of inference models include a plurality of trained models that are trained using training data with different pieces of second region information. The model obtaining unit 104 obtains the inference model corresponding to the aspect ratio.

In step S35, the inference unit 105 obtains characteristic information by inference using the inference model based on the ultrasound image and the target area.

In the above-described processing, the second region information includes the information concerning the visibility of the mammary gland candidate region. The ultrasound image includes a plurality of coordinate values in the depth direction from the epidermis of a subject to the sternum when seen from the ultrasound probe. The information concerning the visibility includes at least one of mammary gland course model-based similarity, the anisotropy of a spatial frequency spectrum, and the image feature amount of the mammary gland candidate region. The inference model includes a trained model that is trained using a plurality of training data including a plurality of pieces of characteristic information and a plurality of ultrasound images corresponding to a plurality of cases. The mammary gland candidate region includes a partial region extracted based on at least one of an atlas-based model and a trained model of the mammary gland.

FIG. 3B is a flowchart illustrating an example of the processing performed by the image processing apparatus 100. In the first embodiment, the processing shown in FIG. 3B is implemented when the CPU 11 executes the program for implementing the function of each unit, which is stored in the main memory 12.

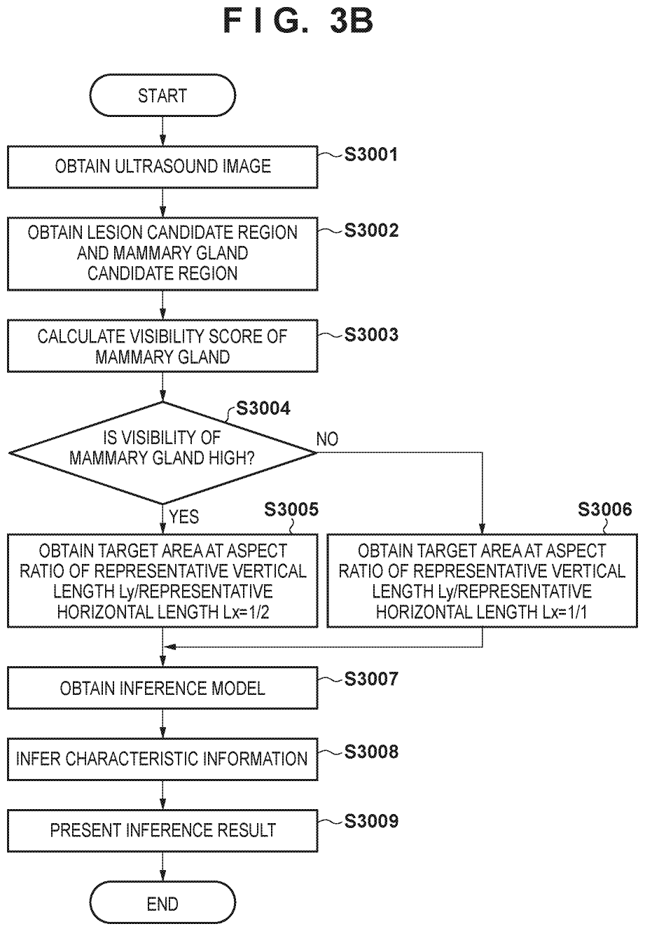

In step S3001, the image obtaining unit 101 obtains an ultrasound image 4A01 (exemplified in 4a of FIG. 4) transmitted from the case information terminal 200 to the image processing apparatus 100. The ultrasound image 4A01 is obtained by pressing the ultrasound probe against the epidermis of a breast applied with a gel to improve acoustic coupling and performing imaging, and the upper end of the image is an acoustic coupling surface 4A02 on the epidermis side of the breast.

In step S3002, the region information obtaining unit 102 obtains region information of a lesion candidate region and region information of a mammary gland candidate region in the ultrasound image. 4b of FIG. 4 shows an example of a lesion candidate region 4B01, and 4c of FIG. 4 shows an example of a mammary gland candidate region 4C01. Assume that for the lesion candidate region 4B01, a rectangular region including a portion around an abnormal shadow 4B02 in the image is used. For example, the lesion candidate region 4B01 is a rectangle having dimensions that are N times (Nis an integer, for example, 2) the width and height of the abnormal shadow 4B02. Thus, even in a case where the range of the abnormal shadow is unclear, such as a case where the edge of the abnormal shadow is unclear, the lesion candidate region 4B01 can include the abnormal shadow 4B02. The width of the abnormal shadow 4B02 is in the direction of the representative horizontal length to be described later, and the height of the abnormal shadow 4B02 is in the direction of the representative vertical length to be described later.

To obtain the lesion candidate region and the mammary gland candidate region, an inference device that infers the regions based on the ultrasound image is constructed in advance by deep learning or the like and used. Note that instead of holding the inference device in the image processing apparatus 100, it may be configured to obtain the lesion candidate region and the mammary gland candidate region of the ultrasound image from an external server (not shown) that provides the same function. Furthermore, the region information obtaining unit 102 may be configured to provide, via the display control unit 106, a GUI for prompting the user to designate arbitrary regions in the ultrasound image, thereby prompting the user to designate the lesion candidate region and the mammary gland candidate region. A region obtained by extending the lesion candidate region may be obtained as a mammary gland candidate region 4E01 without using the inference device that infers the lesion candidate region and the mammary gland candidate region (exemplified in 4e of FIG. 4). In addition, the region information obtaining unit 102 may be configured to exclude the lesion candidate region from the mammary gland candidate region (4D01 or 4F01) (exemplified in 4d of FIG. 4 or 4f of FIG. 4). At this time, by reducing and excluding the lesion candidate region 4B01, it is possible to prevent the mammary gland candidate region around the abnormal shadow 4B02 from being excluded erroneously.

In step S3003, the target area setting unit 103 calculates a score (to be referred to as a visibility score hereinafter) concerning the visibility of the mammary gland from the ultrasound image obtained in step S3001 and the region information of the lesion candidate region and the region information of the mammary gland candidate region obtained in step S3002. In this embodiment, the area ratio of a clear mammary gland candidate region in the mammary gland candidate region to the entire mammary gland candidate region is used as the visibility score.

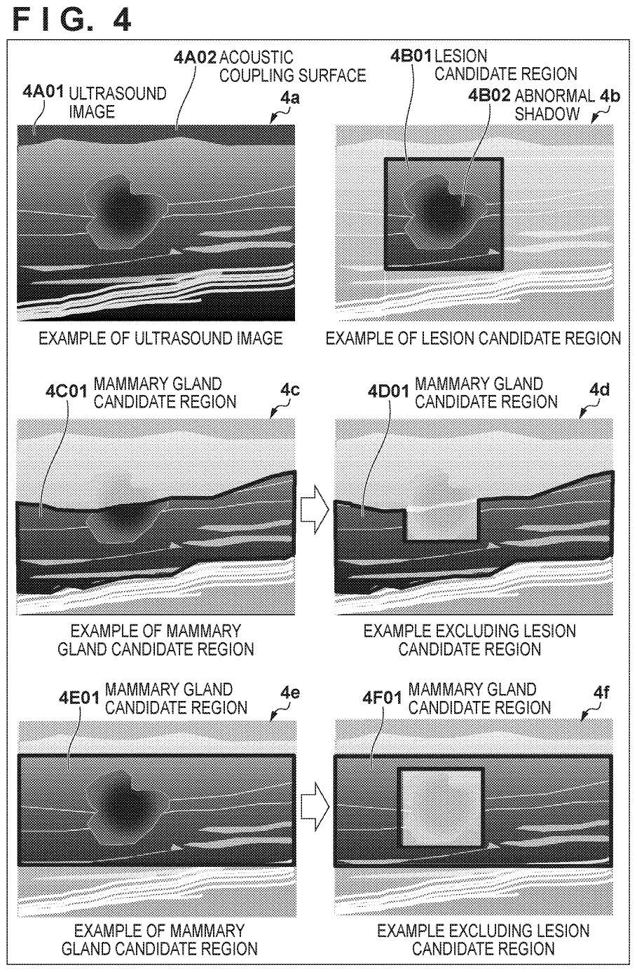

First, the target area setting unit 103 arranges, in the ultrasound image, rectangular regions each having a side of, for example, 32 pixels to be inscribed in the mammary gland candidate region, and generates a patch image 5A01 by cutting out each rectangular region from the ultrasound image (exemplified in 5a of FIG. 5). Note that the size of the rectangular region used to generate the patch image 5A01 is not limited to 32 pixels, and the patch image 5A01 may be generated by using a rectangular region with an arbitrary number of pixels.

Next, the target area setting unit 103 determines whether each patch image is clear (to be referred to as clarity hereinafter). The target area setting unit 103 determines the clarity by the inference device constructed in advance by deep learning or the like using a plurality of data sets each including a pair of an image and a correct answer label representing whether the image is clear. The present disclosure is not limited to this, and it may be configured to infer a continuous value (for example, a value when 0 represents “completely unclear” and 1 represents “completely clear”) representing the degree of clarity and determine, based on a threshold, whether the image is clear. Note that instead of holding the inference device in the image processing apparatus 100, it may be configured to obtain the clarity with respect to the ultrasound image from an external server (not shown) that provides the same function. Furthermore, it may be configured to determine the clarity based on a parameter representing one of visual characteristics of contrast, luminance, chroma, and the like in the patch image without using the inference device. For example, the target area setting unit 103 may determine “clear” in a case where the parameter representing the visual characteristic of each patch image is equal to or larger than a threshold, and determine “unclear” in a case where the parameter is smaller than the threshold. Note that the present disclosure is not limited to the patch image, and the target area setting unit 103 may determine “clear” in a case where a parameter representing one of the visual characteristics of contrast, luminance, and chroma in the ultrasound image or the mammary gland candidate region is equal to or larger than a threshold, and determine “unclear” in a case where the parameter is smaller than the threshold.

Finally, the target area setting unit 103 calculates, as the visibility score, the ratio of the number of patch images determined to be clear to the total number of patch images. A visibility score S_{V} is obtained using a total number N of patch images and a variable Cᵢ representing the clarity of a patch image i, as follows. In this example, Cᵢ takes 1 in a case where the patch image i is clear, and takes 0 otherwise.

$${S}_{V} = \frac{{\sum }_{i = 1}^{N} {c}_{i}}{N} , {C}_{i} ∈ \{ 0 , 1 \} \qquad ( 1 )$$

Note that the size of the region cut out as the patch image is not limited to 32 pixels on each side, and an arbitrary value may be used. For example, as shown in 5b of FIG. 5, a size obtained by dividing, by 10, each side of a rectangular region circumscribed to the mammary gland candidate region may be used (5B01). The division number used to divide each side of the rectangular region circumscribed to the mammary gland candidate region is not limited to 10, and an arbitrary division number may be used.

In step S3004, the target area setting unit 103 compares the visibility score S_{V} calculated in step S3003 with a predetermined threshold T_{S}. If S_{V}≥T_{S}, the target area setting unit 103 determines that the visibility of the mammary gland is high (YES in step S3004), and advances the process to step S3005; otherwise, the target area setting unit 103 determines that the visibility of the mammary gland is low (NO in step S3004), and advances the process to step S3006. In this embodiment, the threshold T_{S} to be used here is obtained by regression by preparing a plurality of data sets each including a pair of the visibility score S_{V} for the ultrasound image and a visibility high/low label.

### <Target Area and Target Reference Shape>

In a case where the process advances to step S3005, the target area setting unit 103 defines the target area in conformance with a target reference shape which surrounds the lesion candidate region to include it and for which the aspect ratio is determined. For the target reference area, a substantially rectangular shape including a rectangle, a rhombus, a trapezoid, an ellipse, and a polygon with four or more sides, for which the aspect ratio is determined, is adopted. The target reference shape has a representative vertical length and a representative horizontal length. The aspect ratio is a ratio obtained by dividing the representative vertical length by the representative horizontal length.

### <Representative Vertical Length and Representative Horizontal Length of Target Area>

A B-mode sectional image of a breast obtained as an input image by the image processing apparatus according to this embodiment is obtained by a transmission wave and a reception wave propagating in the depth direction from a surface acoustically coupled with the ultrasound probe to the sternum side on the body surface side of the chest. For the transmission wave and the reception wave propagating in the depth direction from the body surface to the thorax, a representative sound axis is defined and is substantially perpendicular to the acoustic coupling surface and the body surface. Therefore, the horizontal direction (representative horizontal length) of the target area is determined by the acoustic coupling surface with the ultrasound probe, that is, the body surface at the time of ultrasound echo imaging. The vertical direction (representative vertical length) of the target area is determined in a direction orthogonal to the acoustic coupling surface with the ultrasound probe, and matches the depth direction of the B-mode image.

The representative horizontal length of the target area is determined along the acoustic coupling surface. Since the course of the mammary gland and lymph nodes as common sites of mammary tumors is generally along the body surface, for the sake of convenience, the horizontal direction of the target area can be defined to be parallel to the side in the horizontal direction of an image frame of the B-mode image and the vertical direction of the target area can be defined to be parallel to the side in the vertical direction of the image frame of the B-mode image.

For the vertical and horizontal directions of the target area, the acoustic coupling surface (body surface) or the depth direction can be obtained from meta information added to the B-mode image, the outline of a fan-shaped reconstruction region, and the like. With the meta information, it is possible to uniquely obtain the vertical and horizontal directions of the target area even in a case where the target area is set using, as an input image, an image partially cut out from the B-mode image at the time of imaging.

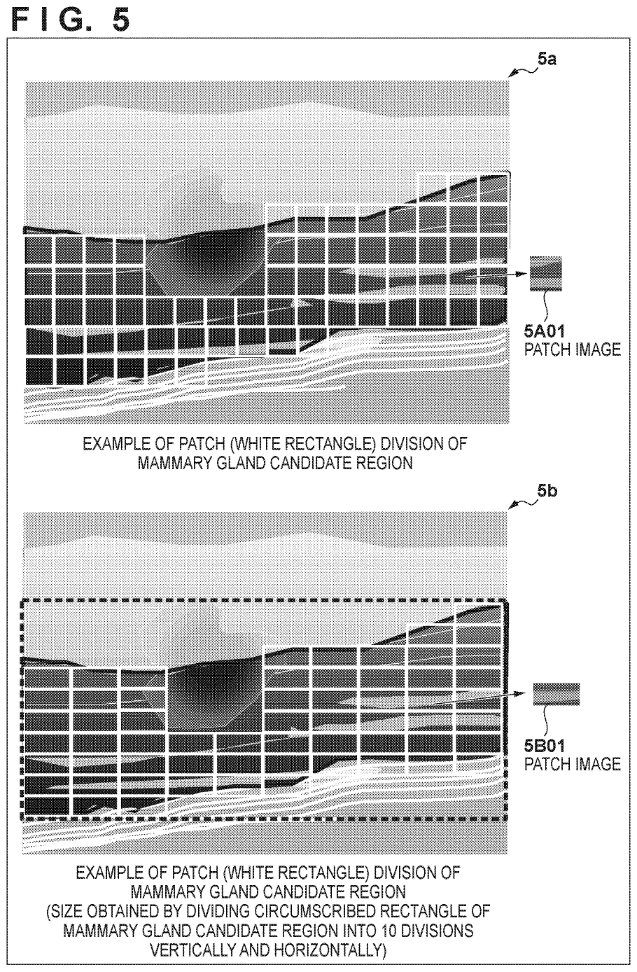

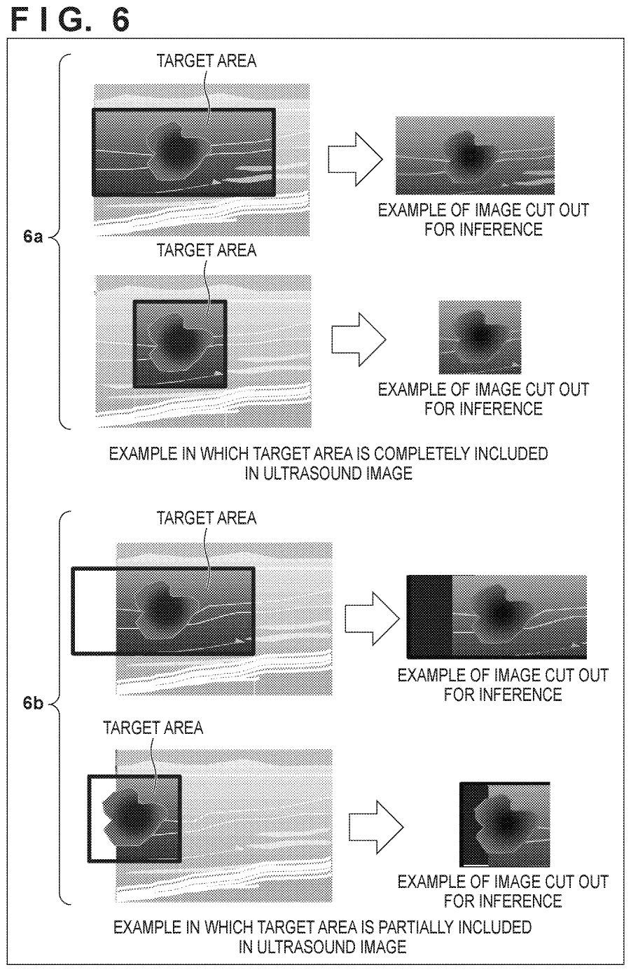

A rectangular region having an aspect ratio of L_{y}/Lₓ=1/2 obtained by dividing a representative vertical length L_{y} by a representative horizontal length Lₓ with reference to the representative vertical length L_{y} surrounding a lesion candidate region 7A01 is obtained as a target area 7A02 (exemplified in 7a of FIG. 7). That is, in a case where an image in which the visibility of the mammary gland is equal to or higher than the predetermined threshold is determined, the target area setting unit 103 sets the target area 7A02 so as to include the lesion candidate region and a region (mammary gland candidate region) whose likelihood of being a mammary gland whose course has continuity in the horizontal direction and discontinuity in the vertical direction is estimated to be high and so as to have high occupancy with respect to these rectangular regions. At this time, the target area 7A02 may be completely included in the ultrasound image (exemplified in 6a of FIG. 6) or may be partially included in the ultrasound image (exemplified in 6b of FIG. 6). In a case where the target area is partially included in the ultrasound image, a target area located outside the ultrasound image undergoes processing of, for example, uniformly filling with a value such as 0, filling with random noise, or generating an image from the periphery (a target area partially included in the ultrasound image) and filling with the image, thereby preventing the influence on inference of the inference unit 105. In this example, the mammary gland candidate region is a region whose likelihood of being the mammary gland whose course has continuity in one direction (for example, the horizontal direction) and discontinuity in the other direction (for example, the vertical direction) intersecting the one direction is estimated to be equal to or higher than a predetermined value, the likelihood being obtained based on the image feature (for example, a predetermined degree of visibility) of the mammary gland candidate region.

On the other hand, in a case where the process advances to step S3006, the target area setting unit 103 obtains, as a target area 7B02, a rectangular region that has a central position substantially matching that of the lesion candidate region and has an aspect ratio of representative vertical length L_{y}/representative horizontal length Lₓ=1/1 with reference to the representative horizontal length Lₓ longer than the vertical length of a lesion candidate region 7B01 (exemplified in 7b of FIG. 7). At this time, the target area 7B02 is extended from the lesion candidate region 7B01. As compared with the case exemplified in 7a of FIG. 7, if the target area setting unit 103 determines an image in which the visibility of the mammary gland is lower than the predetermined threshold, it sets a target area having a shape/size that does not actively include the mammary gland candidate region.

At this time, the target area 7B01 may be completely included in the ultrasound image (exemplified in 6a of FIG. 6) or may be partially included in the ultrasound image (exemplified in 6b of FIG. 6). In a case where the target area is partially included in the ultrasound image, a target area located outside the ultrasound image undergoes processing of, for example, uniformly filling with a value such as 0, filling with random noise, or generating an image from the periphery (a target area partially included in the ultrasound image) and filling with the image, thereby preventing the influence on inference of the inference unit 105.

As exemplified in 7c of FIG. 7, a rectangular region having an aspect ratio of representative vertical length L_{y}/representative horizontal length Lₓ=1/1 with reference to the representative horizontal length Lₓ shorter than the vertical length of a lesion candidate region 7C01 may be obtained as a target area 7C02. At this time, the target area 7C02 is included in the lesion candidate region 7C01. As compared with the case exemplified in 7a of FIG. 7, if the target area setting unit 103 determines an image in which the visibility of the mammary gland is lower than the predetermined threshold, it sets a target area having a shape/size that does not actively include the mammary gland candidate region.

Note that for the aspect ratio exemplified in steps S3005 and S3006, an arbitrary value may be used. However, the aspect ratio with reference to the representative vertical length L_{y} of the lesion candidate region is set to have positive correlation in accordance with the visibility of the mammary gland. For example, in the case of the image in which the visibility of the mammary gland is equal to or higher than the predetermined threshold, an aspect ratio of representative vertical length L_{y}/representative horizontal length Lₓ=1/3 is set, and in the case of the image in which the visibility is lower than the predetermined threshold, an aspect ratio of representative vertical length L_{y}/representative horizontal length Lₓ=1/1.5 is set. That is, in the case of the image in which the visibility of the mammary gland is equal to or higher than the predetermined threshold, the representative horizontal length Lₓ gradually increases in accordance with an increase in visibility of the mammary gland by exceeding the predetermined threshold. Thus, for the image in which the visibility of the mammary gland is equal to or higher than the predetermined threshold, the target area is set to actively include the mammary gland candidate region.

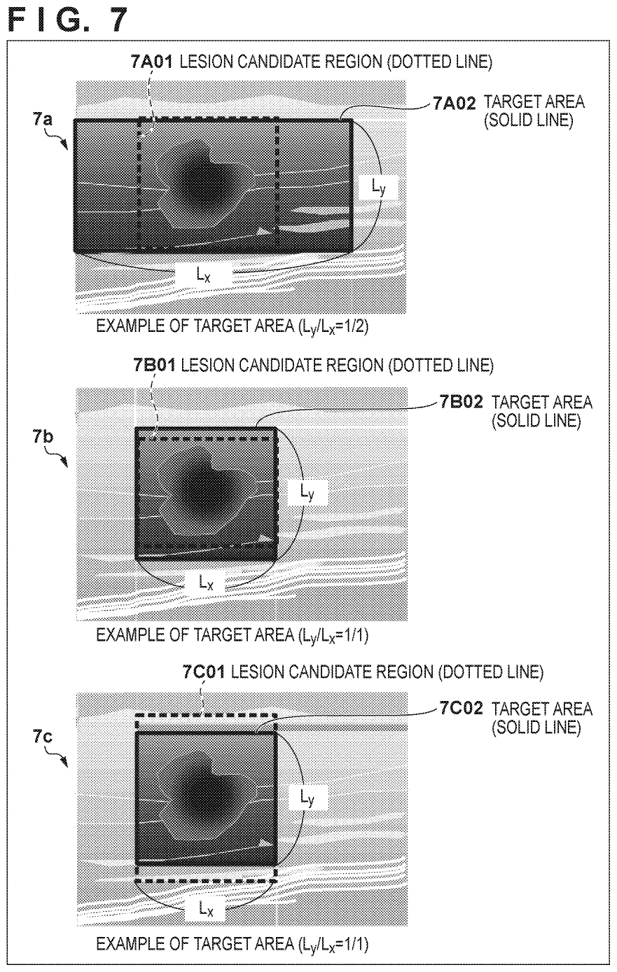

In step S3007, the model obtaining unit 104 obtains a model corresponding to the aspect ratio of the target area. In this embodiment, the model obtaining unit 104 holds, in advance, a plurality of inference models corresponding to the aspect ratios of the target areas, as exemplified in FIG. 8, and then obtains the inference model corresponding to the aspect ratio of the target area obtained in steps S3004 to S3006.

In step S3008, the inference unit 105 infers the characteristic information of the lesion candidate region using the inference model obtained in step S3007 based on the ultrasound image obtained in step S3001 and the target area set in steps S3005 and S3006. In this embodiment, the BI-RADS category (described in, for example, non-patent literature 2) of the lesion candidate region is inferred as characteristic information. To infer the characteristic information, an inference device that infers the characteristic information based on the ultrasound image and the lesion candidate region is constructed in advance by deep learning or the like and used. Note that instead of holding the inference device in the image processing apparatus 100, it may be configured to transmit the ultrasound image and the target area to an external server (not shown) that provides the same function as that of the inference device and cause the inference unit 105 to obtain characteristic information inferred by the server.

The target inferred as the characteristic information is not limited to the BI-RADS category of the lesion candidate region. For example, the characteristic information may be replaced with Japan Association of Breast and Thyroid Sonology (JABTS) category (described in, for example, non-patent literature 3) or the like. For the characteristic information, at least one of the Breast Imaging Reporting and Data System (BI-RADS) category and Japan Association of Breast and Thyroid Sonology (JABTS) category of the lesion candidate region can be adopted.

The characteristic information may be the category such as BI-RADS or JABTS, or the likelihood of each category. Furthermore, the characteristic information may be a continuous value (for example, a value when 0 represents complete benignity and 1 represents complete malignancy) representing the degree of malignancy of the lesion candidate region.

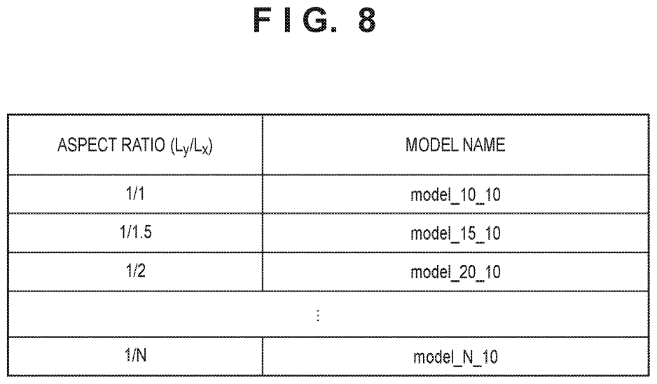

In this embodiment, as exemplified in 9a of FIG. 9, as the inference device, an inference device having a configuration obtained by combining a Convolutional Neural Network (CNN) that performs convolutional processing of an image by receiving, as an input, image data of one channel obtained by cutting out an image of a target area from the ultrasound image and a Deep Neural Network (DNN) that infers characteristic information by receiving the output of the CNN as an input is constructed and used.

As exemplified in 9b of FIG. 9, the ultrasound image and a mask image obtained by masking a portion other than the target area as an image representing the target area may be integrated as different channels into one image data, and then input to the inference device.

It may be configured to input, to the inference device, the ultrasound image obtained by masking a portion other than the target area. As exemplified in 9c of FIG. 9, the inference device may have a configuration in which CNN1 that receives the ultrasound image as an input and CNN2 that receives, as an input, the ultrasound image (masked ultrasound image) obtained by masking a portion other than the target area are separately prepared and combined with a DNN that infers characteristic information by receiving the output of CNN1 and the output of CNN2 as inputs.

If it is determined in step S3004 that the visibility of the mammary gland is high, as exemplified in 9d of FIG. 9, characteristic information may be inferred by preparing CNN1 that receives, as an input, image data obtained by cutting out a target area having an aspect ratio of L_{y}/Lₓ=1/2 from the ultrasound image and CNN2 that receives, as an input, image data obtained by cutting out a target area having an aspect ratio of L_{y}/Lₓ=1/1 from the ultrasound image and combining the output of CNN1 and the output of CNN2. To infer the characteristic information, it is possible to linearly combine the output of CNN1 and the output of CNN2. Note that instead of combining the outputs in the DNN, characteristic information may be inferred by linearly combining (averaging or the like) the output of CNN1 and the output of CNN2. Weights when combining the outputs of CNN1 and CNN2 may be changed in accordance with the visibility score S_{V} of the mammary gland region.

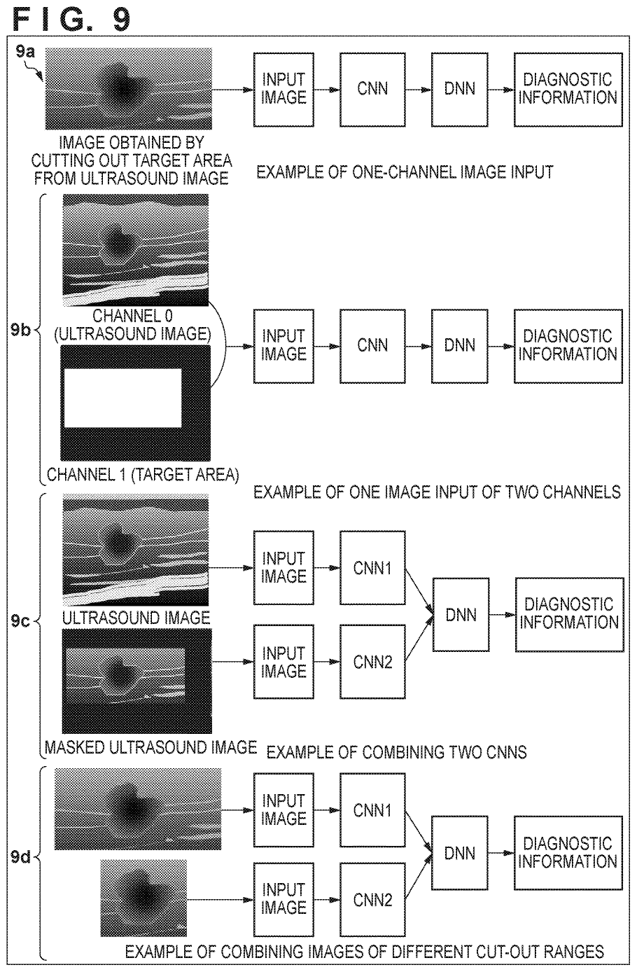

In step S3009, the display control unit 106 displays characteristic information (10A03) obtained in step S3008 on the monitor 15 together with a medical image (ultrasound image (10A02)) and a GUI (exemplified in FIG. 10). The display control unit 106 may also display a target area obtained in steps S3005 to S3007 (10A01). The display control unit 106 may also display a heat map obtained by obtaining, as information representing the basis of inference by the inference model, information for visualizing an image region by Gradient-weighted Class Activation Mapping (Grad-CAM) (described in, for example, non-patent literature 4), and visualizing the image region to be focused on by the inference unit 105 to infer a class by the inference model (10A06). The display control unit 106 may also display, as information representing the basis of inference, a target image (inference image 10A05) cut out from the ultrasound image and input to the inference device. Furthermore, in addition to the characteristic information obtained in step S3008, the display control unit 106 may also display information of an imaging finding of the lesion candidate region, such as a shape and an edge feature (10A04). Furthermore, a function of searching for a similar case based on the displayed contents (10A07), a function of copying or transferring the contents to an external electronic medical record (10A08), a function of outputting a report for printing (10A09), and the like may be provided.

Note that the processing in step S3009 is not always necessary. For example, the characteristic information may be stored/output in/to a storage (not shown) or the like without displaying the characteristic information.

When inferring the characteristic information of the lesion candidate region by the above-described processing, only in a case where the visibility of the mammary gland in the medical image is high, it is possible to extend a target area and use it. This can prevent a decrease in inference performance caused by the input of unnecessary information at the time of inferring the characteristic information and can improve the inference performance of the characteristic information.

### (Modification 1 of First Embodiment)

In step S3003, in order for the target area setting unit 103 to determine the clarity of a patch image, it is not always necessary to construct an inference device that directly determines the clarity from the image and use it.

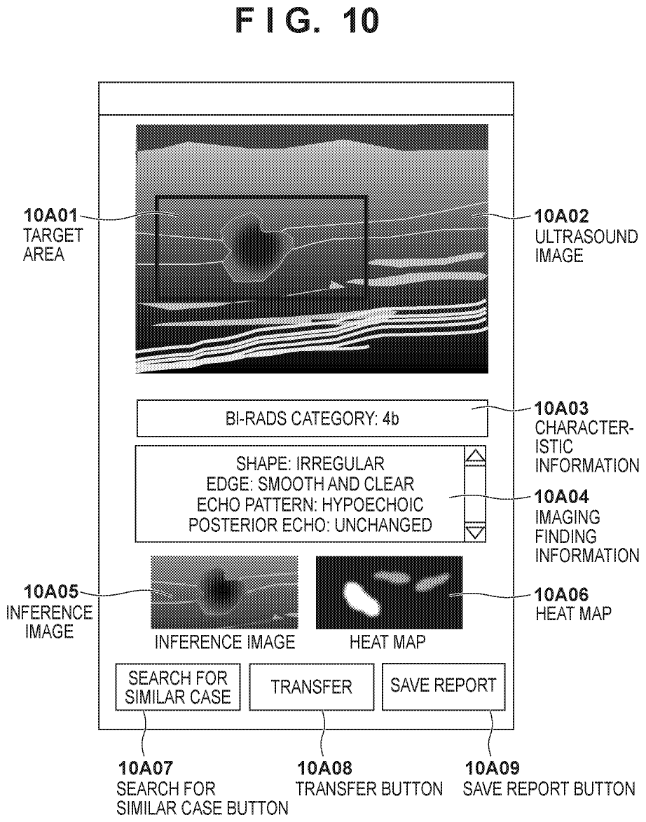

For example, in a case where the ratio of pixels that remain in each patch image when applying, to the patch image, a filter (exemplified in FIG. 11) for extracting an edge in the horizontal direction is equal to or higher than a predetermined threshold T_{P}, it may be determined that the patch image is clear. The threshold T_{P} to be used here is obtained by regression by preparing a plurality of data sets each including a pair of the patch image and a correct answer label representing whether the image is clear.

This can determine the clarity of the patch image in consideration of the direction of the mammary gland.

### (Modification 2 of First Embodiment)

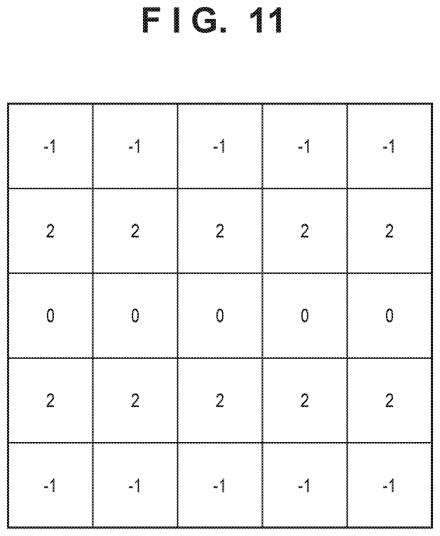

In step S3003, the target area setting unit 103 need not calculate the visibility score S_{V} from all the patch images. For example, as exemplified in 12a of FIG. 12, the visibility score may be obtained only from a patch image 12A03 located at the same depth (the coordinate position in the lower direction when the upper end of the image is set to 0 in a case where the ultrasound probe surface is set as the upper end) as that of a lesion candidate region 12A01 in a mammary gland candidate region 12A02. Furthermore, for example, as exemplified in 12b of FIG. 12, the patch images may be limited to patch images 12B03 near a lesion candidate region 12B01 in a mammary gland candidate region 12B02. The target area setting unit 103 may obtain the area of the clear mammary gland candidate region based on determination of whether each patch image 12B03 located near the lesion candidate region 12B01 within a predetermined range is clear or not, and obtain the visibility score based on the area of the clear mammary gland candidate region.

This can calculate the visibility score S_{V} by limiting to a region usable for inference of the characteristic information such as a region around the lesion candidate region.

### (Modification 3 of First Embodiment)

In step S3003, when calculating the visibility score S_{V}, the target area setting unit 103 may perform weighting based on the distance of the patch image from the center of the lesion candidate region. For example, by using the total number N of patch images, the variable Cᵢ representing the clarity of the patch image i, a distance Di in the horizontal direction of the patch image i from the center of the lesion candidate region, and a weight W(D) based on a distance D in the horizontal direction from the center of the lesion candidate region, the visibility score S_{V} is obtained by:

$${S}_{V} = \frac{{\sum }_{i = 1}^{N} \{ {c}_{i} \cdot {W}_{I} ( \vert {D}_{i} \vert ) \}}{N} , {C}_{i} ∈ \{ 0 , 1 \} \qquad ( 2 )$$

At this time, the variable Cᵢ representing the clarity takes 1 in a case where the patch image i is clear, and takes 0 otherwise. W(D) represents a function, and is designed to have a larger value as the value of the distance D in the horizontal direction from the center of the lesion candidate region is smaller. Note that the design of W(D) is not limited to this, and W(D) may be designed to have a large value in a case where the value of the distance D in the horizontal direction from the center of the lesion candidate region is medium (for example, the value of the distance D is a first distance), and to have a small value in a case where the value of the distance D in the horizontal direction from the center of the lesion candidate region is small (for example, the value of the distance D is a second distance shorter than the first distance) or large (for example, the value of the distance D is a third distance longer than the first distance).

This can calculate the visibility score S_{V} by limiting to a region usable for inference of the characteristic information such as a region close to the lesion candidate region.

### (Modification 4 of First Embodiment)

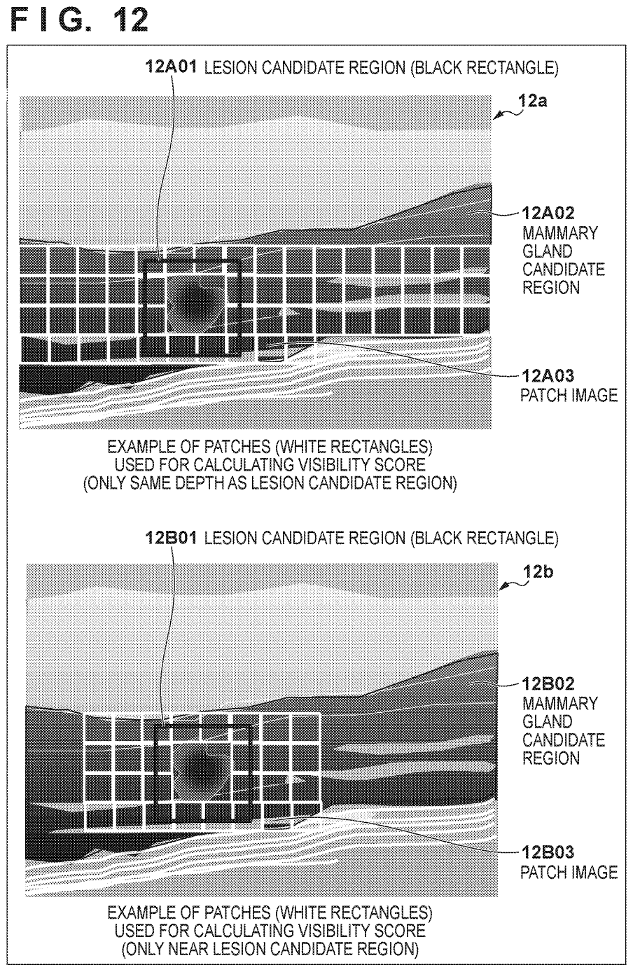

In step S3003, the target area setting unit 103 may calculate the visibility score S_{V} for each of the left and right portions of the lesion candidate region in the mammary gland candidate region (exemplified in 13a of FIGS. 13 and 13b of FIG. 13). For example, a visibility score S_{VL} (13a of FIG. 13) calculated from a left patch image 13A03 of a lesion candidate region 13A01 in a mammary gland candidate region 13A02 and a visibility score S_{VR} (13b of FIG. 13) calculated from a right patch image 13B03 of a lesion candidate region 13B01 in a mammary gland candidate region 13B02 may be separately calculated and the average of them may be set as the final visibility score S_{V}, or it may be determined that the visibility is high only if both S_{VL} and S_{VR} exceed the threshold T_{S}.

This can calculate the visibility score S_{V} in consideration of the connection of the mammary gland around the lesion candidate region.

### (Modification 5 of First Embodiment)

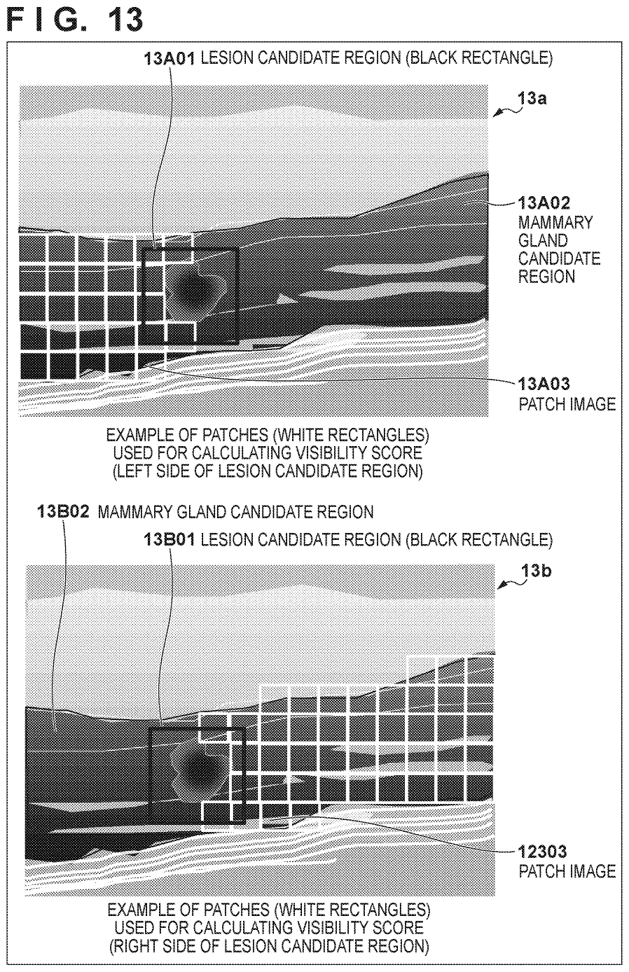

In step S3003, the target area setting unit 103 may directly infer and obtain a clear region 14A02 in a mammary gland candidate region 14A01 (exemplified in FIG. 14). To obtain the region, an inference device that infers the region based on an image is constructed in advance by deep learning or the like and used. Note that instead of holding the inference device in the image processing apparatus 100, it may be configured to obtain the lesion candidate region and the mammary gland candidate region of the ultrasound image from an external server (not shown) that provides the same function. At this time, the visibility score S_{V} is obtained from an area A_{A} of the entire mammary gland candidate region 14A01 and an area A_{C} of the clear region 14A02 by:

S_{V}=A_{C}/A_{A} (3)

In this case as well, the mammary gland candidate region may be divided into a plurality of patch images and a clear region may be obtained for each patch image. The clarity may be determined for each patch image based on the clear region obtained for each patch image, or a region obtained by arranging the clear regions of the patch images may be handled as the clear region of the entire mammary gland candidate region.

This can calculate the visibility score S_{V} in more detail than in a case where the clarity is determined for each patch image.

### (Modification 6 of First Embodiment)

In step S3003, the target area setting unit 103 may detect a linear structure in the mammary gland candidate region, and determine, based on the connection of the structure, whether the visibility is high. For example, the linear structure is, for example, a mammary gland, and an inference device that infers a linear region of the mammary gland based on an image is constructed in advance by deep learning or the like and used. In addition, the edge of the ultrasound image extracted using the filter exemplified in FIG. 11 or the known Canny method may be handled as a linear structure.

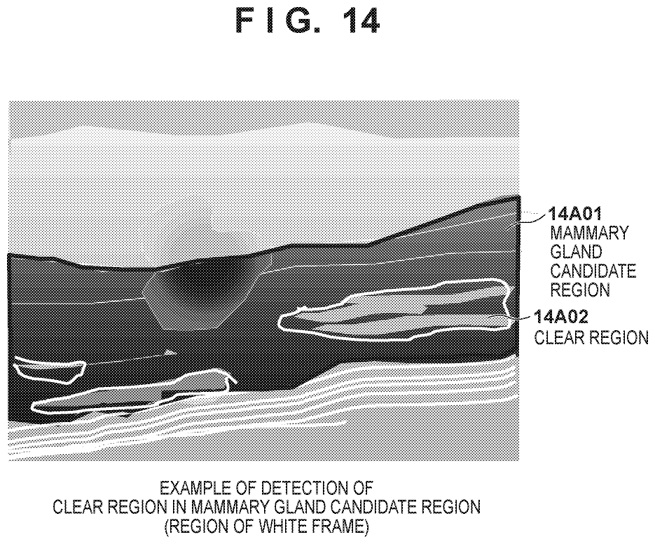

At this time, in step S3004, in a case where the linear structure continues over a lesion candidate region 15A01, as exemplified in FIG. 15, the target area setting unit 103 determines that the visibility of a mammary gland candidate region 15A02 is high. The visibility score S_{V} may be calculated based on the ratio between the length of a continuous linear structure 15A03 and the width of the mammary gland candidate region 15A02. For example, using a width (a length in the horizontal direction along the representative horizontal length) L_{GW} of the mammary gland candidate region 15A02 and a length L_{LW} in the horizontal direction of the longest linear structure 15A03, the visibility score S_{V} is calculated by:

S_{V}=L_{LW}/L_{GW} (4)

This can calculate the visibility score S_{V} in consideration of the connection of the mammary gland around the lesion candidate region.

### (Modification 7 of First Embodiment)

In step S3007, instead of selecting one of different models corresponding to the aspect ratios of the target areas, the model obtaining unit 104 may use one model that is constructed so as to correspond to a plurality of aspect ratios.

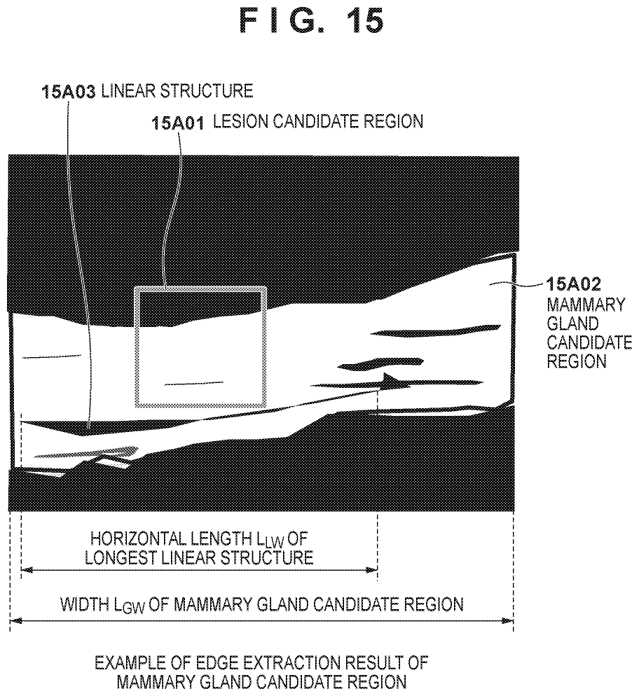

To train this model by deep learning, an image input to the model has a constant size regardless of whether the visibility of the mammary gland is high or low, and is used for learning by excluding, from the image, a region of an aspect ratio that changes depending on whether the visual visibility of the mammary gland is high or not and performing masking (exemplified in 16a of FIGS. 16 and 16b of FIG. 16). Furthermore, different aspect ratio ranges are set for a case where the visibility is high and other cases, and a region excluded from a mask is randomly changed within the range to extend data, thereby preparing for a case where a target area of an unknown aspect ratio is set.

This can reduce the capacity of the model stored in a storage device such as a Hard Disk Drive (HDD) or Solid State Drive (SSD), as compared with a case where the plurality of models corresponding to the aspect ratios of the target areas are selectively used.

### (Modification 8 of First Embodiment)

In step S3008, the inference unit 105 may apply additional processing to the ultrasound image or the target area before inferring characteristic information. For example, the edge of the ultrasound image may be enhanced using a known Sobel filter or Laplacian filter, and the thus obtained image may be used for inference.

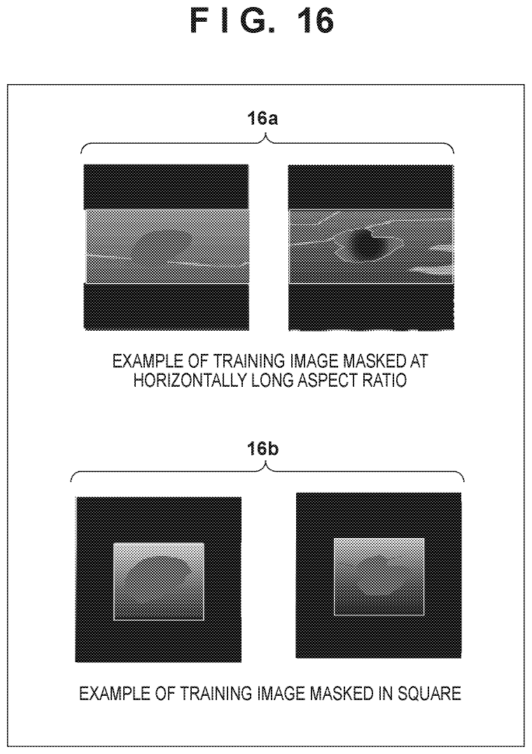

For example, a target area 17A01 in a mammary gland candidate region 17A02 may be extended to a target area 17A04 to include the position of a patch image 17A03 determined in step S3003 to be clear (exemplified in FIG. 17).

By performing these processes only if it is determined in step S3004 that the visibility of the mammary gland is high, it is possible to input the image to the inference device by enhancing the information of the mammary gland candidate region necessary for inference of characteristic information.

### (Modification 9 of First Embodiment)

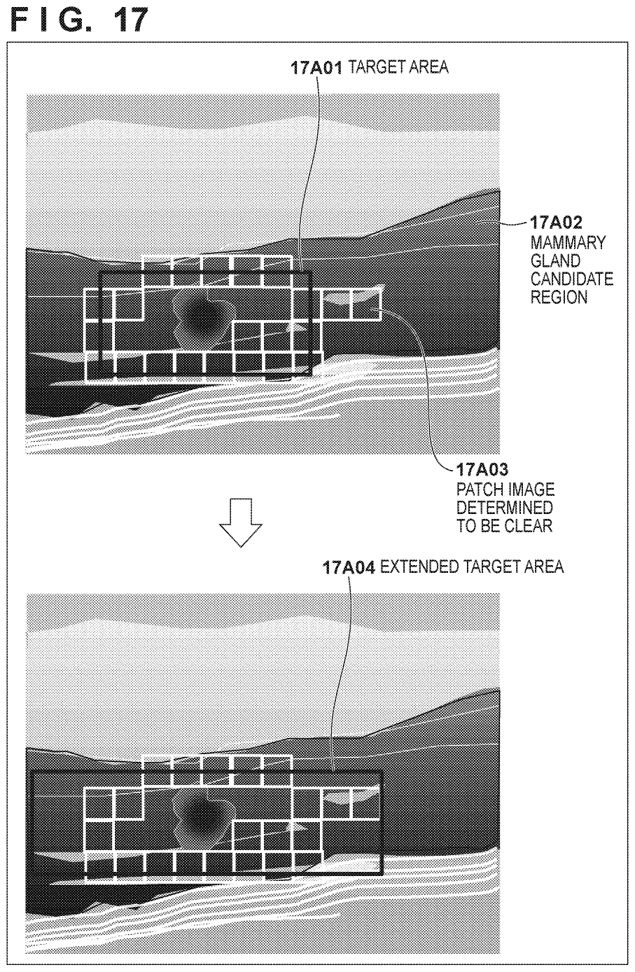

In steps S3005 and S3006, the target area setting unit 103 may directly obtain the target area without determining the aspect ratio. For example, if it is determined in step S3004 that the visibility of the mammary gland is high in a mammary gland candidate region 18A02, a target area 18A01 may be determined to include a patch image 18A03 determined in step S3003 to be clear, as shown in, for example, FIG. 18.

By performing these processes only if it is determined in step S3004 that the visibility of the mammary gland is high, it is possible to input the image to the inference device by enhancing the information of the mammary gland candidate region necessary for inference of characteristic information.

### Second Embodiment

An image processing apparatus according to the second embodiment changes the aspect ratio of a target area stepwise in accordance with the visibility of a mammary gland. The image processing apparatus according to the second embodiment has the functional configuration shown in FIG. 2, similar to the first embodiment.

### (Processing Procedure)

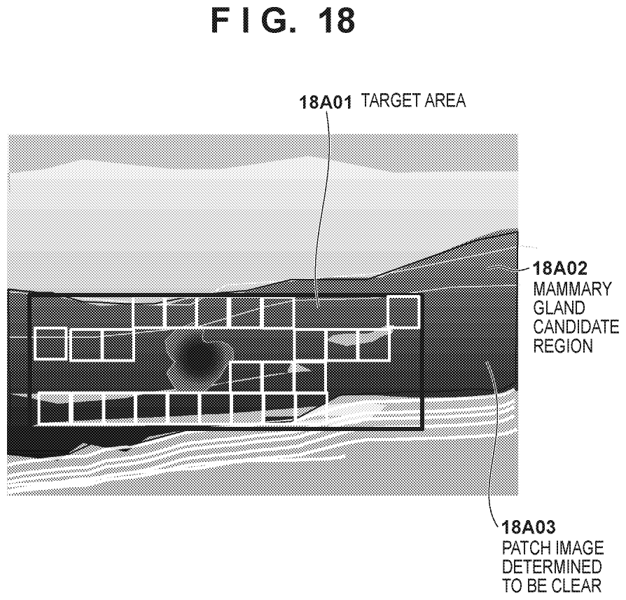

FIG. 19 is a flowchart illustrating an example of processing executed by an image processing apparatus 100 according to the second embodiment. Steps S3001, S3002, and S3007 to S3009 are the same as in the first embodiment. Only differences from the first embodiment will be described below.

In step S19001, a target area setting unit 103 according to the second embodiment calculates the visibility score of the mammary gland using information of the clarity of each patch image obtained by the same method as in step S3003 of the first embodiment. When calculating a visibility score S_{V}, the target area setting unit 103 according to the second embodiment performs weighting so that the score is higher as the distance of the patch image from the center of a lesion candidate region is longer. For example, the visibility score S_{V} is obtained using a total number N of patch images, a variable Cᵢ representing the clarity of a patch image i, a width L_{IW} of a medical image (ultrasound image), and a distance Dᵢ in a horizontal direction of the patch image i from the center of the lesion candidate region, as follows. At this time, Cᵢ representing the clarity of the patch image i takes 1 in a case where the patch image i is clear, and takes 0 otherwise. In equation (5) below, |distance Dᵢ|/width L_{IW} of medical image (ultrasound image) represents a weight coefficient that is larger as the distance of the patch image from the center of the lesion candidate region is longer.

$${S}_{V} = \frac{{\sum }_{i = 1}^{N} \{ {C}_{i} \cdot ( \vert {D}_{i} \vert / {L}_{IW} ) \}}{N} , {C}_{i} ∈ \{ 0 , 1 \} \qquad ( 5 )$$

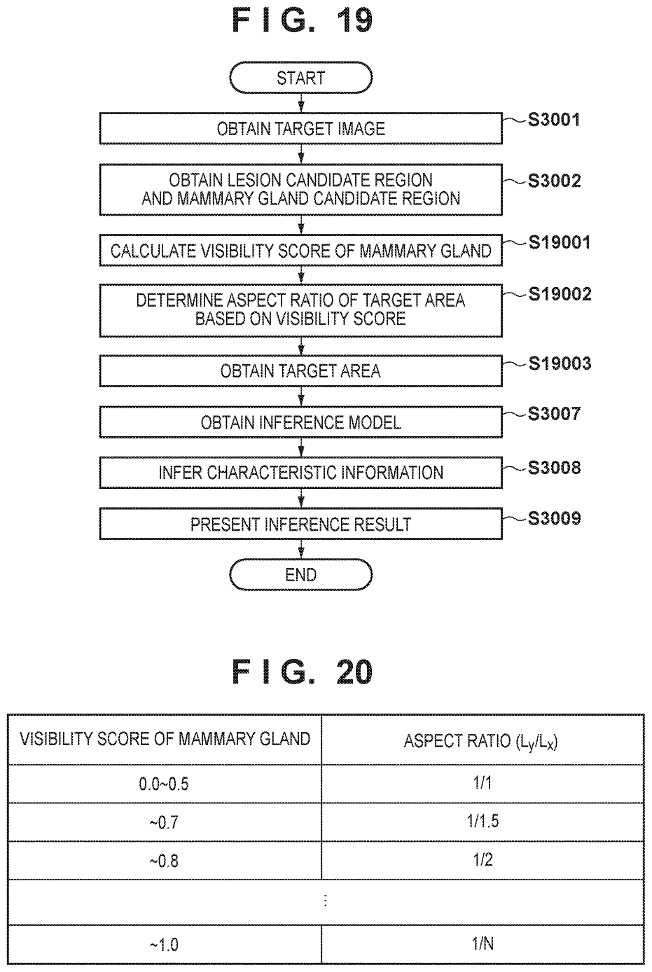

The target area setting unit 103 determines a different aspect ratio based on the visibility score S_{V}, and obtains a target area so as to include the lesion candidate region based on the aspect ratio. In step S19002, the target area setting unit 103 according to the second embodiment determines a different aspect ratio of the target area based on the visibility score S_{V} of the mammary gland using a table exemplified in FIG. 20.

In step S19003, the target area setting unit 103 according to the second embodiment obtains, as the target area, a rectangular region that has a central position substantially matching that of the lesion candidate region and has the aspect ratio determined in step S19002 based on representative vertical length L_{y}/representative horizontal length Lₓ with reference to the representative vertical length L_{y} of the lesion candidate region. The aspect ratio in this step is determined, as in 7a of FIG. 7 of the first embodiment.

Thus, in a case where a high-visibility mammary gland candidate region exists at a position far from the lesion candidate region, it is possible to include the corresponding region in the target area.

According to the technique of the disclosure, it is possible to improve performance at the time of inferring information concerning characteristics of a lesion candidate region based on an ultrasound image including a breast within an imaging range, and prevent a decrease in performance caused by the use of unnecessary information for inference.

According to the technique of the disclosure, it is possible to provide an image processing technique with high inference performance for inferring information concerning characteristics of a breast from an ultrasound image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-083496, filed May 19, 2025, which is hereby incorporated by reference herein in its entirety.

What is claimed is:

1. An image processing apparatus comprising:
a memory storing instructions, and
at least one processor configured to execute the instructions to
obtain an ultrasound image by capturing at least a portion of a breast;
obtain first region information and second region information as region information of a lesion candidate region and region information of a mammary gland candidate region included in the ultrasound image;
set a target area for inferring characteristic information concerning a characteristic of the lesion candidate region based on the first region information and the second region information;
obtain an inference model that infers the characteristic information; and
obtain the characteristic information by inference using the inference model based on the ultrasound image and the target area.

2. The apparatus according to claim 1, wherein the second region information includes information concerning visibility of the mammary gland candidate region.

3. The apparatus according to claim 2, wherein the ultrasound image includes a plurality of coordinate values in a depth direction from epidermis of a subject to a sternum when seen from an ultrasound probe.

4. The apparatus according to claim 2, wherein the information concerning the visibility includes at least one of mammary gland course model-based similarity, anisotropy of a spatial frequency spectrum, and an image feature amount of the mammary gland candidate region.

5. The apparatus according to claim 1, wherein the inference model includes a trained model that is trained using a plurality of training data including a plurality of pieces of characteristic information and a plurality of ultrasound images corresponding to a plurality of cases.

6. The apparatus according to claim 5, wherein the at least one processor is configured to obtain the inference model from a plurality of inference models.

7. The apparatus according to claim 6, wherein the plurality of inference models include a plurality of trained models that are trained using training data with the different pieces of second region information.

8. The apparatus according to claim 1, wherein the mammary gland candidate region includes a partial region extracted based on at least one of an atlas-based model and a trained model of a mammary gland.

9. The apparatus according to claim 1, wherein the at least one processor is configured to set the target area so as to include the mammary gland candidate region and the lesion candidate region and to obtain high occupancy of the mammary gland candidate region and the lesion candidate region in the target area.

10. The apparatus according to claim 3, wherein
in a case where the depth direction is set as a vertical direction and a direction intersecting the depth direction is set as a horizontal direction,
the at least one processor is configured to set the target area based on the information concerning the visibility of the mammary gland candidate region so as to have a representative vertical length in the vertical direction, a representative horizontal length in the horizontal direction, and an aspect ratio as a ratio obtained by dividing the representative vertical length by the representative horizontal length based on the second region information.

11. The apparatus according to claim 10, wherein the at least one processor is configured to set the target area based on the aspect ratio having positive correlation in accordance with the visibility of the mammary gland candidate region.

12. The apparatus according to claim 1, wherein in a case where the target area is partially included in the ultrasound image, the at least one processor is configured to set the target area by at least one of
a method of assigning a random noise value as a pixel value with respect to a target area located outside the ultrasound image, and
a method of extending a target area located outside the ultrasound image by a generation target area image generated based on a target area partially included in the ultrasound image.

13. The apparatus according to claim 10, wherein the at least one processor is configured to
divide the mammary gland candidate region into a plurality of regions along the representative horizontal length of the lesion candidate region,
obtain information concerning the visibility for each divided region, and
obtain the information concerning the visibility of the mammary gland candidate region by integrating the pieces of information concerning the visibility of the divided regions.

14. The apparatus according to claim 10, wherein the at least one processor is configured to
perform processing of extracting an edge from the ultrasound image,
obtain, as a linear structure included in the ultrasound image, the edge extracted by the processing, and
evaluate the information concerning the visibility of the mammary gland candidate region in accordance with whether the linear structure continues by exceeding the representative horizontal length of the lesion candidate region.

15. The apparatus according to claim 10, wherein the at least one processor is configured to set the target area so as to include the lesion candidate region based on the first region information.

16. The apparatus according to claim 10, wherein the at least one processor is configured to obtain the inference model corresponding to the aspect ratio.

17. The apparatus according to claim 1, wherein the characteristic information includes at least one of a Breast Imaging Reporting and Data System (BI-RADS) category and a Japan Association of Breast and Thyroid Sonology (JABTS) category.

18. The apparatus according to claim 1, wherein the at least one processor is configured to display the characteristic information on a display together with the ultrasound image,
wherein the at least one processor is also configured to display, on the display, at least one of information representing a basis of inference by the inference model, information of an imaging finding of the lesion candidate region, and the target area.

19. An image processing method for an image processing apparatus, comprising:
obtaining an ultrasound image by capturing at least a portion of a breast;
obtaining first region information and second region information as region information of a lesion candidate region and region information of a mammary gland candidate region included in the ultrasound image;
setting a target area for inferring characteristic information concerning a characteristic of the lesion candidate region based on the first region information and the second region information;
obtaining an inference model that infers the characteristic information; and
obtaining the characteristic information by inference using the inference model based on the ultrasound image and the target area.

20. A non-transitory computer-readable storage medium storing a program for causing a computer to execute an image processing method defined in claim 19.
